(19) United States
(12) Patent Application Publication
(10) Pub. No.: US 2021/0188600 A1
(43) Pub. Date: Jun. 24, 2021

(54) SYSTEM FOR OPERATING A LOAD-HANDLING CRANE, AND LOAD-HANDLING CRANE AND METHOD FOR OPERATING SAME

(71) Applicant: Konecranes Global Corporation, Hyvinkää (FI)

(72) Inventors: Holger Freitag, Bochum (DE); Giuliano Persico, Wetter (DE); Oliver Moll, Solingen (DE)

(21) Appl. No.: 16/757,261

(22) PCT Filed: Oct. 18, 2018
(86) PCT No.: PCT/EP2018/078589

§ 371 Date: Apr. 17, 2020

(30) Foreign Application Priority Data
Oct. 18, 2017 (DE) 10 2017 124 278.3

(51) Int. Cl. B66C 13/44; B66C 17/00; B66C 13/30; B66C 13/56

(52) U.S. Cl. CPC B66C 13/44; B66C 17/00; B66C 2700/085; B66C 13/56; B66C 13/30

(57) ABSTRACT

A load-handling crane, and a system and method are provided for operating the load-handling crane having a hoist movable by means of a drive of the crane and a handling device for operating the crane. The handling device is fastened to a liftable and lowerable suspension element of the hoist and having a sensor system for determining an orientation of the suspension element, or of a part fastened to the suspension element, or of the handling device, or of a load-handling attachment. The system further has an operating element that cooperates with the sensor system such that, when the operating element is actuated, a control command for activating the drive is able to be triggered, resulting in the hoist being movable by means of the drive in a direction of travel, with the direction of travel being dependent on an orientation determined by means of the sensor system.

### CROSS REFERENCE TO RELATED APPLICATIONS

The present application is a § 371 national stage of International Application PCT/EP2018/078589, filed Oct. 18, 2018, which claims priority benefit of German Pat. Application DE 10 2017 124 278.3, filed Oct. 18, 2017.

### FIELD OF THE INVENTION

The invention relates to a load-handling crane, and a system and method for operating the load-handling crane.

### BACKGROUND

Cranes are generally used to lift and lower loads at mutually different locations within their working area. For this purpose, a hoist of the crane is moved by means of a travel drive in a typically horizontal direction of travel if an operator triggers corresponding control commands for the travel drive, and thus operates the crane, by manipulating a handling device of the crane, which is formed for example as a control switch. To this end, control switches, as an interface between an operator and the crane, include operating elements that can be actuated by an operator in terms of manipulating the handling device in order to thereby trigger the respective control commands for the travel drive and a lifting drive of the crane. The operating elements can be designed as physical operating elements that are to be actuated mechanically, such as by spring-loaded buttons or push-buttons, rotary or slide controls and latching or non-latching switches, and/or a touch-sensitive surface. Moreover, corresponding control switches or the operating elements, a control unit of the crane and the drives (travel drive and the lifting drive) are connected together in a signal-transmitting manner for triggering and/or transmitting control commands, in order to be able to actuate the drives by means of the control commands The control switch can be configured for wireless signal transmission, such as by radio or infrared remote control, or for wired signal transmission as a pendant control switch which is suspended on a signal-transmitting cable, also referred to as a control line.

In so-called load-handling cranes, the handling device optionally configured as a control switch is not attached, as in the above-mentioned conventional cranes, outside the carrying means, which can be lifted and lowered, of the crane or its hoist, but is rather attached to, and thus in particular suspended on, a section of the carrying means suspended from the travel plane and above a load picking-up means likewise suspended on the carrying means. In particular, the load picking-up means can also be attached to the carrying means exclusively via the handling device, and so the handling device is attached to the carrying means in a load-bearing manner and thus as part of the load string. Attaching the handling device to the carrying means allows an operator, unlike in the situation in conventional cranes mentioned above, to trigger control commands for the crane or drives thereof and to manually dampen swinging movements of the carrying means and any possible load attached to the load picking-up means by manipulating the handling device with one hand and at the same time using the same hand.

DE 297 19 865 U1 discloses a suspension crane designed as a load-handling crane in the above-described sense, in which the handling device is not designed as a control switch including operating elements. Instead, in order to operate the crane, provision is made that an operator exerts, as manipulation, a manual force on the handling device and, via this, on the carrying means, which force causes a deflection of a cable used as a carrying means including any possible load suspended thereon from its rest position and thus with respect to the direction of gravitational force. The direction of deflection of the carrying means with respect to the direction of gravitational force is determined by means of a sensor system and is interpreted as a desired direction of travel of the hoist, and so simply owing to the determined deflection or direction of deflection corresponding control commands for the travel drive of the crane are triggered and are converted by the travel drive into movement of the hoist in a direction of travel corresponding to the direction of deflection of the carrying means.

Another load-handling crane designed as a suspension crane is known from the brochure “Produktivität mit Fingerspitzengefühl—Demag KBK Drive Assist” from Terex MHPS GmbH (which can be retrieved at http://www.demagcranes.com/Leichtkransystem-KBK-Drive-Assist). In this crane, the hoist can also be moved in a desired direction of travel simply by the previously-described deflection of its carrying means caused by a corresponding manipulation of the handling device attached to the carrying means. Furthermore, the handling device of the crane is designed as a control switch, which accordingly includes an operating element, by means of the actuation of which, likewise occurring as a manipulation of the handling device, the lifting drive of the crane or its hoist for lifting or lowering a load can be controlled.

A system known from US 2004/0026349 A1 discloses that deflection angles of the load are determined in order to be able to then perform crane movements corresponding to the determined angle. In that document it is also described that a correction of unintended twisting of the carrying means can be carried out.

Similar systems that require a load deflection for effecting crane movements are known from DE 20 2016 002 296 U1 and U.S. Pat. No. 6,738,691 B1.

In the previously described prior art, an intuitive operation of the respective load-handling crane is thus possible in each case because the hoist is always moved in the respective direction of deflection of the carrying means. In particular, loads having a relatively large weight, for example of more than 50 kg, may require a high application of force by the operator in order to cause the deflection of the carrying means including picked-up load, which is necessary to actuate the travel drive and/or in order to influence swinging movements in a dampening manner. In the long run, this is tiring for the respective operator.

In this context, in particular in cases with an undesirable ratio between the weight of the load and the weight of the operator or the force exerted thereby, there is also the risk that the orientation of the carrying means effected in the form of the deflection does not occur with the desired precision, or no longer occurs with the desired precision owing to tiredness, and thus movement of the hoist including the load initially does not occur in the actually desired direction of travel.

U.S. Pat. No. 7,461,753 B1 discloses a load-handling system having an end effector. By actuating a first joystick, a vertical movement of the end effector can be triggered. By means of a second joystick, a horizontal movement of the end effector can be triggered in that the joystick is tilted in the desired direction. In the case of the horizontal movement triggered by tilting the second joystick accordingly, a rotational angle of a rotary column used as a carrying means, to which the end effector is attached, is taken into consideration. Alternatively, the end effector can also be attached to a cable instead of a rotary column, wherein an electronic compass is then used.

### SUMMARY OF THE INVENTION

The present invention provides a load-handling crane and a corresponding system and method for operating such crane in a manner in particular for assembling and cargo-handling processes, such that safety is increased and requires less outlay even when handling relatively heavy loads. In one form of the present invention, a system for operating a load-handling crane, the hoist of which can be moved in a preferably horizontal travel plane by means of a travel drive of the crane, includes a handling device for operating the crane, wherein the handling device is provided and configured for attachment to a section of a carrying means of the hoist, which section can be lifted and lowered and is suspended from the travel plane, i.e. at least below the travel plane, in order to allow an operator to trigger control commands for the crane or drives thereof and also to manually guide and orientate the carrying means and any possible load suspended thereon and to manually dampen swinging movements of the carrying means and the load by manipulating the handling device which the operator can do in particular with one hand and at the same time using the same hand. The handling device can be attached to the section of the carrying means suspended from the travel plane, which can be configured to be flexible, such as a cable or chain, in particular above a load picking-up means suspended on the carrying means. Provision can also be made that the handling device, in particular the housing thereof, is configured to be arranged and attached in a load-bearing manner between the section of the carrying means and the load picking-up means on the carrying means. As a result, the handling device, just like the load picking-up means, becomes a part of the load string of the hoist extending the carrying means, by means of which load forces emanating from a load attached to the load picking-up means are introduced into the carrying means via the handling device, in particular the housing thereof. Accordingly, the load picking-up means can be attached and suspended on the handling device, in particular the housing thereof, and thus on the carrying means via the handling device. A simple change between different load picking-up means, such as load hooks, grippers, etc. can hereby be permitted, in that a receptacle for releasably attaching the respective load picking-up means is formed on the handling device or the housing thereof. The handling device and in particular the housing thereof can thus be configured on the whole and can be connected to the load picking-up means in such a manner that a movement, and in particular rotation, of the handling device produces an equal movement of the load picking-up means including any possible load attached thereto, and vice-versa.

The system in accordance with an aspect of the invention also includes a sensor system for determining an orientation of the suspended section of the carrying means and/or an orientation of a part attached thereto and thus suspended on the carrying means. This part can be in particular the handling device and/or the load picking-up means. Provision is also made that the system includes an operating element which co-operates with the sensor system such that by actuating the operating element a control command can be triggered to actuate the travel drive, by means of which the hoist can be moved in the travel plane in a direction of travel by means of the travel drive and the direction of travel is dependent upon an orientation determined by means of the sensor system. The operating element includes two operating parts, the actuation of which in each case triggers control commands for opposite directions of travel in terms of forwards travel and rearwards travel, for which purpose the two operating parts are configured in the form of a first button for forwards travel and a second button for rearwards travel, optionally in each case as push-buttons to be mechanically actuated, each having at least one actuation stage. The improvement of such system is achieved in that the sensor system is configured to determine that orientation of the section, suspended from the travel plane and extending in the direction of gravitational force, of the carrying means and/or of the part attached thereto can be altered by a rotation of the section or part about a rotational axis extending in the direction of gravitational force. Contrary to the situation in the prior art mentioned above, as a result it is no longer necessary to deflect the carrying means with respect to the direction of gravitational force in the desired direction of travel in order to specify the desired direction of travel and to trigger a corresponding control command for the travel drive, and so the application of force previously associated therewith can be completely obviated for the respective operator.

The operating element of the system is optionally arranged on the handling device and in particular on the housing thereof, whereby this is then configured as a control switch. By means of the travel drive, the hoist can be moved in the travel plane in a direction of travel of the crane and/or in a direction of travel of the trolley perpendicular thereto, in each case independently of each other, which directions produce, individually or in combination by superposition thereof, the direction of travel of the hoist in the travel plane. The direction of travel is thus a direction which extends in, and in parallel with, the horizontal travel plane in the direction of travel of the crane and/or the direction of travel of the trolley. Via an operating part of the operating element or a further already-provided operating element provided on the handling device, control commands can also be triggered for the lifting drive by respectively actuating the operating part/element, and so the handling device can also be configured as a control switch without the operating element for the travel drive.

Optionally, the direction of travel dependent upon the determined orientation is specified for the control command also by actuation of an operating element and as a result the direction of travel is allocated to the determined orientation in a predefined manner. The operating element can be the same operating element or the operating part thereof, the actuation of which triggers the control command, wherein in particular the same actuation can trigger the control command and can also specify the associated direction of travel. It is also feasible that two actuations are required to trigger the control command. For this purpose, the operating element or operating part thereof can include a first actuation stage for a first actuation for specifying the direction of travel in dependence upon the determined orientation and a second actuation stage for a second actuation for subsequently triggering the actual control command taking into consideration the previously specified direction of travel. Alternatively, two separate operating elements can also be provided which are preferably each arranged on the handling device or the housing thereof and of which one is used for a first actuation for specifying the direction of travel and one is used for a second actuation for triggering the control command The operating element for specifying the direction of travel can then include two operating parts for the forwards travel and the rearwards travel.

In other words, only by actuating the corresponding operating element or operating part or the corresponding actuation stage can the hoist be moved in the travel plane by means of the travel drive in a direction of travel, wherein the direction of travel is dependent upon the orientation determined by means of the sensor system. As a result, the safety during load handling is substantially increased because the required actuation prevents, in terms of a safety function, for example an orientation in the form of a deflection of the section of the carrying means suspended from the travel plane with respect to the direction of gravitational force from being converted immediately into a driving manoeuvre effected by the travel drive in a possibly unintended direction of travel. The required actuation of an operating element instead allows an operator to initially effect an orientation corresponding to the desired direction of travel. Only by actuating the operating element is the actual control command for actuating the travel drive then triggered, by means of which the hoist is moved in the direction of travel depending upon the orientation, or prior to triggering the control command initially, the effected orientation is confirmed for specifying the desired direction of travel for the control command. As a result, it would also be possible, after a brief deflection of the suspended carrying means section for specifying the desired direction of travel for a control command and the actuation of the operating element or the actuation stage for triggering the corresponding control command, to then cancel the deflection without as a result the specified direction of travel and/or control command also being cancelled. In addition, changes in orientation which are used to manually dampen any swinging movements of the carrying means via corresponding manipulation of the handling device can no longer be falsely interpreted as supposedly intended triggering of a control command, unlike in the prior art stated above.

By actuating the corresponding operating element or operating part or the corresponding actuation stage, initially the orientation which is determined, in particular during the respective actuation, and can be changed such as by a corresponding manipulation of the handling device, can hereby be taken into consideration such that the direction of travel dependent on the determined orientation is specified in terms of a desired directional value for a control command for actuating the travel drive. For this purpose, the system optionally includes a correspondingly configured evaluation unit connected to the sensor system in a signal-transmitting manner. By taking into consideration this desired directional value, the actual control command can then be triggered or generated by way of the actuation or a further actuation of the corresponding operating element/operating part or the corresponding actuation stage and the travel drive can be controlled using the control command such that the hoist is moved in the direction of travel specified in accordance with the desired directional value by means of the travel drive with a driving manoeuvre.

In this context, the desired directional value can initially be transmitted from the evaluation unit to a control unit of the crane in order to be taken into consideration there, in addition to desired speed values, when triggering, i.e. generating, the actual control command for the travel drive. By means of the control command, the control unit then controls the travel drive such that the hoist is moved by means of the travel drive with the specified direction of travel and speed. The control unit can be arranged, just like the evaluation unit, on or in the handling device and in particular within the housing thereof. By means of the control unit, the lifting drive of the hoist can also be controlled, in that a corresponding operating element is actuated on the handling device. Alternatively, the control unit and the evaluation unit can also be arranged outside the handling device. The control unit can then also be divided so that one part of the control unit used to actuate the trolley drive for movement in the direction of travel of the trolley is arranged on the crane trolley as a trolley controller and one part of the control unit used to actuate the crane drive for movement in the direction of travel of the crane is arranged as a crane controller outside the crane trolley on the crane girder or at least one of the crane running gear units. The trolley controller can then also actuate the lifting drive. In order to permit the transmission of signals which correspond at least to the determined orientations, desired directional and speed values and/or control commands having such desired values, the operating element and thus in particular also the handling device, the sensor system, the evaluation unit, the control unit and the travel drive are configured to be interconnected in a signal-transmitting manner. The signals can be transmitted between the parts of the system in a wireless or wired manner.

In terms of the present invention, the orientation can relate to at least two reference points, which are defined in a mutually distinguishable manner on the section of the carrying means suspended from the travel plane or the respective part attached thereto used to determine the orientation. The first reference point can be defined for example on a handle of the handling device provided for an operator, and the second reference point can be defined on a side of a housing wall of the handling device opposite the handle. The two reference points can be immovable relative to each other. It is also feasible that one or both reference points is/are defined on the carrying means.

In order to determine the orientation, such as the position of the two reference points and/or the position or location of a notional straight line containing the reference points can then be determined relative to a coordinate plane defined by the sensor system. The coordinate plane used as a reference system for the orientation to be determined can be a Cartesian coordinate system or also a polar coordinate system. The orientation can be determined in particular in the form of coordinates of the reference points and/or a gradient and/or an angle of the notional straight line relative to the respective coordinate system. When the orientation is determined in the form of an angle, this can be a rotational angle, preferably an absolute rotational angle, which can be changed in particular by rotating the carrying means and/or the part attached thereto and, associated therewith, by rotating the notional straight line about a rotational axis. The rotational angle can be determined in particular relative to a reference orientation. For example, an orientation in parallel with an axis of the coordinate plane and/or the travel plane can be defined as a reference orientation. The sensor system can be configured and arranged accordingly to determine the orientation with and/or without a corresponding rotational angle.

The specifying of the direction of travel for the travel drive, depending upon the determined orientation, can be effected as a predefined allocation of a directional vector to the determined orientation, which can be represented for example by the notional straight line containing the reference points, or the rotational angle thereof. In this context, in terms of a coordinate transformation, an arithmetic allocation of the orientation determined relative to the coordinate plane of the sensor system to the coordinate plane of the travel drive defined by the direction of travel of the crane and the direction of travel of the trolley can be effected. The directional vector, such as with an angle of zero degrees with respect to the determined or transformed orientation, can be specified as the direction of travel before or after the coordinate transformation, which vector is directed from the first to the second of the two reference points. The specified direction of travel then extends along, or in parallel with, the notional straight line representing the orientation in the respective coordinate plane. As a result, a change in the orientation relative to the respective coordinate plane effects a correspondingly equal change in the directional vector and thus the direction of travel specified in dependence upon the determined orientation. The determination of the coordinates, to be specified, of the direction of travel for the associated drives of the travel drive (crane drive and trolley drive) can be effected arithmetically including the occurring coordinate transformation and allocation of the directional vector and can be performed for example by the above-mentioned evaluation unit, and in particular its computing unit which can be arranged in particular within the housing of the handling device.

The sensor system can be arranged, in accordance with yet another aspect of the invention, completely on the crane and can be movable therewith for determining the orientation. It is hereby possible that the sensor system, as described in more detail hereinafter, is completely suspended on the carrying means, or is even fastened at least in part on the crane trolley, or outside the crane trolley on the crane girder. The coordinate plane of the sensor system can thus also be moveable, and in particular inclinable, with respect to the travel plane, and the position thereof can be changed such as by a swinging movement of the carrying means. It is also possible for the sensor system to be arranged at least partially outside the crane, and in particular in a stationary manner there. Provision can be made in particular that the coordinate plane of the sensor system extends in parallel with the preferably horizontal travel plane, or contains the travel plane. This is also possible when the sensor system is arranged outside of the carrying means on the crane. Depending upon the type and arrangement of the sensor system, the notional straight line can be inclined with respect to the coordinate plane, for example when the handling device is inclined, and thus also the reference points defined on the handling device are spaced apart from the travel plane, or the coordinate plane by different amounts. The orientation, which can be determined by the sensor system, can then correspond to a vertical projection of the reference points, or the associated notional straight line on the coordinate plane.

In all arrangement variations, the sensor system includes a sensor in terms of a measuring means or measuring element in order to determine the respective orientation on the basis of a corresponding measurement. In this sense, the sensor system can be configured for example to determine the orientation on the basis of an optical measurement of the reference points. The reference points can also be provided with a transmitting means, such as in the form of light sources for each reference point, which cooperates with a sensor of the sensor system, which sensor is then used as a receiver, such as in the form of a camera in order to determine the orientation which is possible when using light sources for example by means of triangulation or travel time measurement. The sensor system can also be configured to determine the orientation on the basis of ultrasound measurement. A sensor system which measures the orientation according to the radio-location principle is likewise feasible. In order to determine the orientation in the form of a rotational angle, the sensor system, then configured as a rotational angle sensor system, can include for example a compass, in particular an electronic compass, or a sensor in the form of a Hall sensor, in particular a 3D Hall sensor, and a magnetic body, or can at least cooperate therewith. The coordinate plane of the sensor system relative to the rotational axis can be defined by the compass or the Hall sensor and the magnetic body and the respective arrangement thereof. This is applicable in particular when the sensor system is suspended completely on the carrying means. Details in this respect are described in more detail hereinafter.

Furthermore, provision can be made to configure the sensor system to continuously determine the orientation and cooperate with the operating element to be actuated, to specify the direction of travel in such a manner that the specified direction of travel remains unchanged or is continuously changed when the operating element to be actuated to specify the direction of travel is permanently actuated and the orientation changes in the meantime.

As already discussed above, the orientation for specifying the direction of travel for a control command for the travel drive can be, in accordance with an aspect of the invention, an orientation which does not require deflection of the suspended carrying means section with respect to the direction of gravitational force and thus away from its swinging-free rest position. To specify the desired direction of travel for a control command, the freely suspended carrying means section and the parts suspended thereon, such as the handling device and the load picking-up means, can accordingly remain in the deflection-free, gravitational force-induced rest position, and for example the orientation of the handling device relative to the coordinate plane of the sensor system can be determined and specified for a control command. A change in the orientation required to change the specified direction of travel can then occur for example by rotating the handling device about the rotational axis, whereby the position of at least one of the two reference points and thus the location of the associated notional straight line is changed. For this purpose, the handling device, or at least a section of the housing thereof, is suspended in a rotatable manner relative to the carrying means and/or the carrying means can be twisted about its longitudinal extent. Instead of the orientation of the handling device, the orientation of the carrying means, or another part attached to the carrying means, for example an orientation of the load picking-up means, can also be determined, by defining corresponding reference points at that location which are relevant for determining the orientation. When using the system, in accordance with an aspect of the invention, load-handling cranes can thus now also be used for relatively larger loads having a weight of for example more than 50 kg, without the above-described safety risk arising. Also in the case of correspondingly large loads, the load-handling crane can be operated to move the hoist with considerably less force having to be applied manually.

In a further embodiment of the invention, provision can be made that the sensor system is configured to also determine that orientation of the section of the carrying means suspended from the travel plane and/or the part attached thereto, which can be changed by rotating the section or part about the rotational axis extending in an inclined manner with respect to the travel plane and is independent of any possible inclination of the rotational axis with respect to the direction of gravitational force. This can also be the above-mentioned rotational axis after it has been deflected such as by a swinging movement of the carrying means with respect to the direction of gravity. Any swinging or deflection of the carrying means with respect to the direction of gravitational force without any occurring rotation about the rotational axis then has no influence whatsoever on the specification of the direction of travel and/or the triggering of control commands In other words, the sensor system can be used to thus determine that orientation which is independent of whether the carrying means section and/or the handling device and the load picking-up means extend in the direction of gravity, or are in their rest position, or are deflected with respect thereto. The rotational axis can intersect in particular the carrying means section or can coincide therewith and/or can intersect a part, attached to the carrying means, in particular the handling device and/or the load picking-up means. This can be the case for example when a longitudinal axis of the handling device is defined as the rotational axis and at least one section of the handling device, such as a section of the housing thereof, can be rotated about same.

In a structurally simple manner, provision can be made that the sensor system is configured to be attached and suspended at least partially, preferably completely, on the carrying means and to be arranged in particular between the carrying means and the load picking-up means, preferably between the carrying means and the handling device. As a result, the components of the sensor system on the whole can be arranged on the crane, such that the determination of the orientation cannot be hindered by an operator located between the sensor system and the carrying means or the part attached thereto.

Furthermore, provision can be made that the system includes a rotary arrangement, by means of which the handling device, in particular together with at least one part of the sensor system, can be attached to the carrying means, and can be attached so as to be rotatable relative to the carrying means and about the rotational axis. For this purpose, the rotary arrangement includes a first rotary element, which can be connected to the handling device, in particular the housing thereof, for conjoint rotation therewith, and includes a second rotary element, which can be connected to the carrying means for conjoint rotation therewith. The two rotary elements can be rotatable relative to each other, in particular about the above-described rotational axis or defining same, and can be supported with respect to each other such as via rolling bodies when the rotary arrangement includes an axial bearing formed as a roller bearing.

The part of the sensor system which is rotatable together with the handling device is connected, just like the handling device, to the rotary arrangement, in particular the same one of the two rotary elements, for conjoint rotation therewith. As mentioned above, this can be for example a compass, a Hall sensor or a magnetic body. The rotary arrangement, in particular the housing thereof, can also be attached and suspended on the carrying means, just like the handling device, in a load-bearing manner and thus as part of the load string. Decoupling of the handling device and the carrying means in relation to force flow is then achieved by the rotary arrangement in such a manner that a torque applied to the handling device or the housing thereof is not transmitted to the carrying means. In this manner, the handling device, the load picking-up means attached thereto in particular for conjoint rotation with respect to the handling device, and an attached load can be freely rotated, wherein the carrying means is not twisted or is only twisted to a negligible extent. Owing to the decoupling by the rotary arrangement located between the carrying means and housing, the housing can theoretically be continuously rotated relative to the carrying means. This permits a precise orientation of the attached load, without the operator having to manually apply force to compensate for a returning torque owing to twisting of the carrying means. The suspended carrying means section can extend permanently in the direction of gravitational force, wherein the rotational axis then extends in parallel therewith or coincides therewith. Of course, the rotary arrangement can also be used when the handling device is suspended on the carrying means in a non-load-bearing manner and thus in parallel with the load string in terms of force flow. This is applicable for all of the embodiments of the system described above.

In order to minimise in particular undesired twisting of the section of the carrying means suspended from the travel plane with respect to the longitudinal extent thereof or even to completely prevent such twisting of the carrying means, an element for reducing twisting of the carrying means can be provided which is preferably more twisting-resistant than the carrying means itself formed for example as a chain. The element for reducing twisting of the carrying means can be connected to the carrying means for conjoint rotation therewith, in particular indirectly via that rotary element of the rotary arrangement, which for its part can be connected to the carrying means, in particular its section suspended from the travel plane, for conjoint rotation therewith. The element for reducing twisting of the carrying means can be connected at its opposite end in the region of the travel plane to the hoist, in particular the housing thereof, likewise for conjoint rotation therewith. The element for reducing twisting of the carrying means is optionally configured such that its length can be adjusted accordingly during lifting or lowering and the associated movement of the carrying means section suspended from the travel plane. The element for reducing twisting can be in particular a hose, preferably a spiral hose. The carrying means can then be accommodated within the hose and extend in particular spaced apart from the wall of the hose. In the case of wired signal transmission, in addition the signal-transmitting cable used for this purpose and also referred to as a control line can be accommodated within the hose and in particular can be attached to the wall thereof and/or can be integrated in the wall. The signal-transmitting cable can also be designed as a spiral-shaped helical line. This allows the length of the hose to be adapted in a simple manner during lifting or lowering and the corresponding movement of the carrying means section.

In a structurally simple manner, the rotary arrangement can have a housing having an opening, through which a connecting body which can be connected to the handling device can engage and can be supported on the housing with its collar within the housing. The collar can be supported within the housing via an in particular annular contact surface on the housing wall delimiting the opening. In a comparable manner, the connecting body can be supported with a second collar within the housing of the handling device, which for this purpose likewise includes a corresponding opening into which the connecting body can engage. By means of the connecting body, a conjoint-rotation connection can thus be achieved between the handling device and the rotary arrangement or the corresponding rotary element thereof, which connection permits in particular a frictional and also form-fitting transmission of forces as a result of any possible torque and the weight of any possible load. As a result, the conjoint-rotation connection between the part of the sensor system which is rotatable together with the handling device and the associated rotary element of the rotary arrangement can also be ensured, in particular when this is attached to the collar of the connecting body. Any other possible part of the sensor system, i.e. for example the Hall sensor or the magnetic body, and the other rotary element can then each be connected together and to the carrying means for conjoint rotation therewith, and can likewise be arranged in the housing of the rotary arrangement, in that the two rotary elements can be supported on the housing wall.

In a further embodiment, provision can be made that a load sensor is provided which is configured to detect the weight of the respective load acting on the carrying means, wherein desired values for speed and/or acceleration and/or deceleration of the travel drive can be adapted in dependence upon the detected weight of the load. For this purpose, the load sensor can be arranged for example on the carrying means itself, or in, or on the housing of the handling device in the load string. In particular, when the speeds, accelerations, and decelerations are reduced as the weight increases, the resulting swinging movements of the load moving in a suspended manner, and thus the force applied manually by the respective operator to dampen same, can be reduced.

Furthermore, the invention is directed to a load-handling crane, the hoist of which can be moved in a travel plane by means of a travel drive of the crane, having a handling device for operating the crane, which is attached to a section of a carrying means of the hoist, which is suspended from the travel plane and can be lifted and lowered. Such a crane can be improved in accordance with an aspect of the invention in that it is provided with a system as described above for operating same. The resulting advantages have already been described above in greater detail in conjunction with the system, in accordance with the invention, and reference is made thereto at this juncture.

The invention further includes a method for operating a load-handling crane, the hoist of which can be moved in a travel plane by means of a travel drive of the crane. In a particular manner, the crane can be the crane in accordance with an aspect of the invention mentioned above, which includes a handling device for operating the crane that is attached to a section of a carrying means of the hoist, which is suspended from the travel plane and can be lifted and lowered. An orientation of the carrying means and/or of a part attached to the carrying means, in particular the handling device and/or a load picking-up means, is determined by means of a sensor system. In order to operate the crane, the respective operator always grasps the load string of the crane, in particular via the handling device arranged on or in the load string, in order to specify and/or alter the respective direction of travel of the hoist in the travel plane by changing the orientation of the carrying means and/or the part attached thereto. Provision is also made in such a method that only by actuating an operating element cooperating with the sensor system is a control command triggered to actuate the travel drive, by means of which the hoist can be moved in the travel plane in a direction of travel by means of the travel drive, and the direction of travel is dependent upon an orientation determined by means of the sensor system. The operating element includes two operating parts, the actuation of which in each case triggers control commands for opposite directions of travel in terms of forwards travel and rearwards travel, for which purpose the two operating parts are configured in the form of a first button for forwards travel and a second button for rearwards travel, optionally in each case as push-buttons to be mechanically actuated, each having at least one actuation stage. Such a method is improved, in accordance with an aspect of the invention, by virtue of the fact that the sensor system is configured to determine that orientation of a section, suspended from the travel plane and extending in the direction of gravitational force, of the carrying means and/or of the part attached thereto, which can be altered by a rotation of the section or part about a rotational axis extending in the direction of gravitational force. The system, in accordance with an aspect of the invention described here, can be used in particular in the method for operating a load-handling crane, to which then the advantages thereof apply accordingly. In particular, the operating element can thus be arranged on the handling device and the handling device can thus be configured as a control switch.

In accordance with another aspect of the invention, provision can also be made that the direction of travel is specified for the control command in dependence upon the determined orientation by actuating the operating element or another operating element, in particular of the above system.

By configuring the above-described system accordingly, it can also be achieved in particular that the specified direction of travel optionally remains unchanged, or is varied continuously, when the operating element to be actuated for specifying the direction of travel is permanently actuated and the orientation of the carrying means section and/or the part attached thereto set by the operator and accordingly determined by the sensor system changes in the meantime. Accordingly, the sensor system can be used to continuously determine the orientation and so when the operating element is permanently actuated, the specification of the direction of travel can also be continuously adapted to follow the orientation, which changes if need be for example by corresponding manipulation of the handling device, and can be converted into corresponding driving manoeuvres having changing directions of travel. Alternatively, it is also feasible that a change in the orientation is ignored when the operating element is permanently actuated and a driving manoeuvre is continued with the previously specified direction of travel. In this case, provision can then be made that the travel drive has to be stopped initially, for example by terminating the actuation of the operating element, and so only upon re-actuation of the operating element does the changed orientation effect the specification of a correspondingly changed direction of travel in terms of an amended desired directional value for a new control command, which can then be converted into a driving manoeuvre having a correspondingly changed direction of travel.

These and other objects, advantages and features of the invention will become apparent upon review of the following specification in conjunction with the drawings.

### BRIEF DESCRIPTION OF THE DRAWINGS

An exemplified embodiment of the invention will be explained in greater detail with reference to the following description. In the drawings:

FIG. 1 shows a perspective and schematic view of a load-handling crane in accordance with the invention;

FIG. 2 shows a view of a handling device and rotary arrangement of the crane of FIG. 1; and

FIG. 3 shows a sectional view through the rotary arrangement and a part of the handling device of FIG. 2.

### DESCRIPTION OF THE PREFERRED EMBODIMENTS

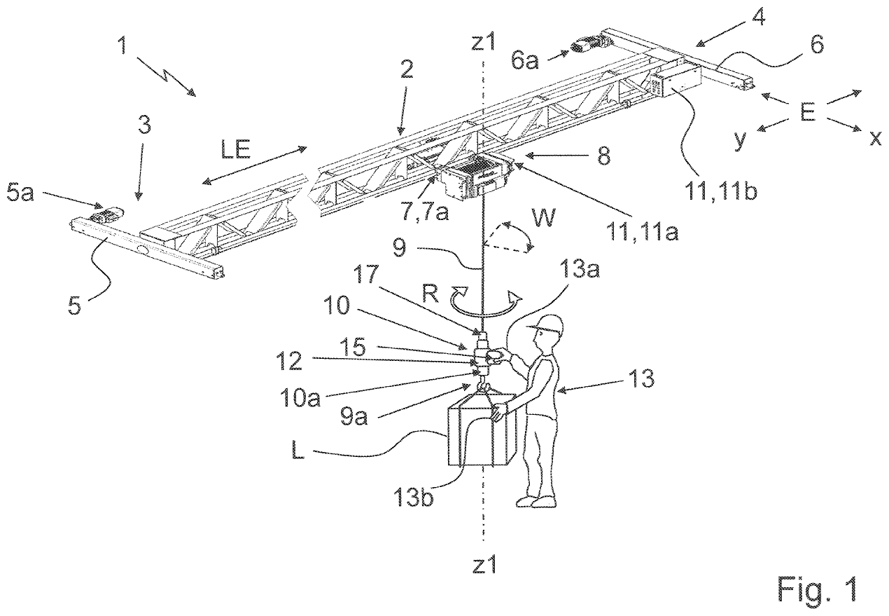

FIG. 1 shows a perspective view of load-handling crane 1 in accordance with the present invention. The crane 1 is shown by way of example as a single-girder bridge crane having a crane girder 2 configured as a lattice girder. The crane 1 can be moved as a whole in a direction of travel of the crane x on rails, not illustrated, by means of crane running gear units 5, 6, which are attached to opposite ends 3, 4 of the crane girder 2 forming a crane bridge. The rails are raised with respect to the ground in a conventional manner, and for this purpose can be elevated, for example via a suitable support structure, or can be attached to mutually opposing building walls and/or on a building ceiling which are then used as a support structure.

Of course, alternative embodiments not illustrated here in more detail for the crane 1, in particular the crane girder 2 and the rails, are also feasible. For instance, the crane 1 can be formed such as a suspension crane. In the case of a suspension crane, the rails and also the crane girder 2 can be formed by rail profiles which generally have a c-shaped cross-section open at the bottom in its mounting position. In the mounting position, the crane bridge formed by the crane girder 2 is then suspended via the crane running gear units 5, 6 on the rails suspended for example on a building ceiling used as a support structure, wherein the crane running gear units 5, 6 are inserted from beneath into the rail profiles and can move within the rail profiles on craneways formed at that location. The following statements in relation to the present crane 1 apply accordingly to a load-handling crane formed as a suspension crane.

The crane girder 2 extends with its longitudinal extent LE horizontally and transversely, in particular perpendicularly, to the direction of travel of the crane x. The crane 1 or its crane girder 2 can be moved in the direction of travel of the crane x via the crane running gear units 5, 6 driven by a motorised crane drive. The crane drive preferably includes an electric motor 5a and 6a for each crane running gear unit 5 and 6 respectively. A crane trolley 7 having a hoist 8 is arranged on the crane girder 2 and can be moved in a direction of travel of the trolley y, by means of its trolley running gear unit 7a driven by a motorised trolley drive, together with the hoist 8 on the crane girder 2 along the longitudinal extent LE thereof and thus transversely, in particular perpendicularly, to the direction of travel of the crane x. The trolley drive preferably likewise includes an electric motor. In the case of a suspension crane, the crane trolley 7 can be moved with its trolley running gear unit 7a in an identical manner within the crane rail 2 on a trolley-way at that location, like the crane running gear units 5, 6 within the respective rail on the craneway.

The running gear units 5, 6 and 7a and the motorised drives thereof form a travel drive of the crane 1. By way of a targeted actuation of the crane drive and/or the trolley drive, the crane trolley 7, and thus the hoist 8, can be moved in a direction of travel in a motorised manner in, and in parallel with, a preferably horizontal travel plane E. The direction of travel thus corresponds to the direction of travel of the crane x, or the direction of travel of the trolley y, or the superposition thereof.

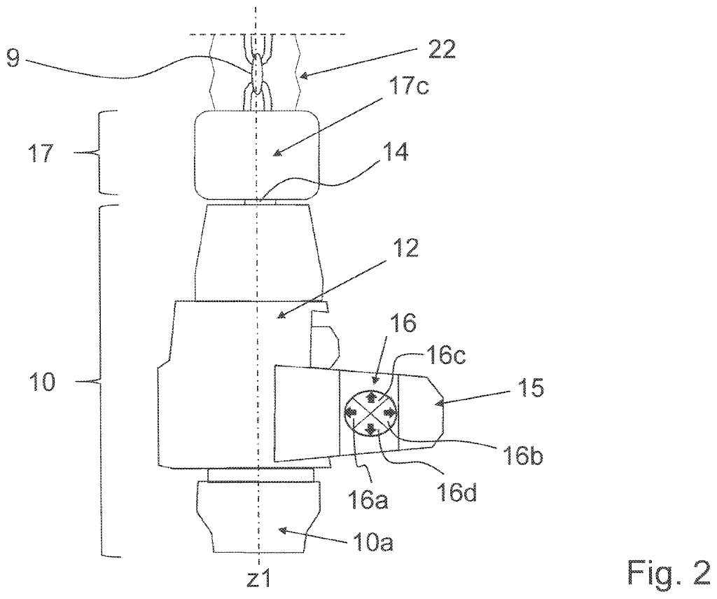

Via a lifting drive of the hoist 8, which is motorised by means of an electric motor, a flexible and string-like carrying means 9 of the hoist 8, or its section suspended from the travel plane E, and a load picking-up means 9a that is attached thereto, and is thus suspended, having a possible load L attached to the load picking-up means 9a can be lifted or lowered. The carrying means 9 can also be designed, in addition to the present exemplified embodiment as a cable, as a chain, and so the hoist 8 is then not formed as a cable winch but as a chain hoist. The load picking-up means 9a includes by way of example a load hook and is attached and suspended on the carrying means 9 and thus on the load string, in particular via a handling device 10 in the load string attached to the carrying means 9 in a load-bearing manner. As a result, the crane 1 is formed as a load-handling crane 1 in the sense defined in the introduction. The load-bearing connection between the load picking-up means 9a and the handling device 10 for attaching the load picking-up means 9a to the carrying means is optionally a conjoint-rotation connection in order to be able to move and thus handle a load L in a particularly precise manner by corresponding manipulation of the handling device 10. For this purpose a handle 15 is arranged on a housing 12 of the handling device 10 which can be grasped by the respective operator 13 using one hand 13a in order to be able to guide and orientate the carrying means 9 and thus the load string including any possible load L by a corresponding manual force, and thus to be able to dampen any possible swinging movements. The other hand 13b of the operator 13 can be in direct contact with the load L and assist the guiding and orientating or dampening and so for this purpose both hands 13a, 13b are available on the whole, as is typical for load-handling cranes. Moreover, the handling device 10 is provided with an operating element 16 (see FIG. 2) for operating the crane 1 and is thus configured as a control switch.

The crane 1 also includes a control unit 11 that is connected to the handling device 10, or its operating element 16, and also to the travel drive and the lifting drive of the crane 1 in terms of control technology and in particular in a signal-transmitting manner. When an operator 13, in particular with the hand 13a grasping the handle 15, at the same time actuates the operating element 16, corresponding control commands for actuating the drives or the electric motors thereof in particular mutually independent manner are triggered by the control unit 11, and so the crane 1 is operated thereby and the associated crane movements, in particular driving manoeuvres in the travel plane E and lifting and lowering movements of the carrying means 9 perpendicular thereto can be effected. The operating element 16, which can be seen in FIG. 2, includes for this purpose two operating parts in the form of a “forwards travel” button 16a and a “rearwards travel” button 16b for triggering control commands having opposing directions of travel (desired directional values) for the travel drive. Moreover, the operating element 16 includes two further operating parts in the form of a “lift” button 16c and a “lower” button 16d for actuating the lifting drive of the hoist 8 and thus for triggering corresponding desired values and/or control commands.

The control unit 11 can be divided such that one part 11a of the control unit 11 used for actuating the trolley drive, and in particular also the lifting drive, is arranged on the crane trolley 7 as a trolley controller, and one part 11b of the control unit 11 used to actuate the crane drive is arranged as a crane controller outside the crane trolley 7 on the crane girder 2 or at least one of the running gear units 3, 4. Alternatively, the control unit 11 can also be incorporated in the handling device 10 or the housing 12 thereof, at least with both parts 11a and 11b, and from there can actuate the lifting drive and also the travel drive (crane drive and trolley drive) (not shown).

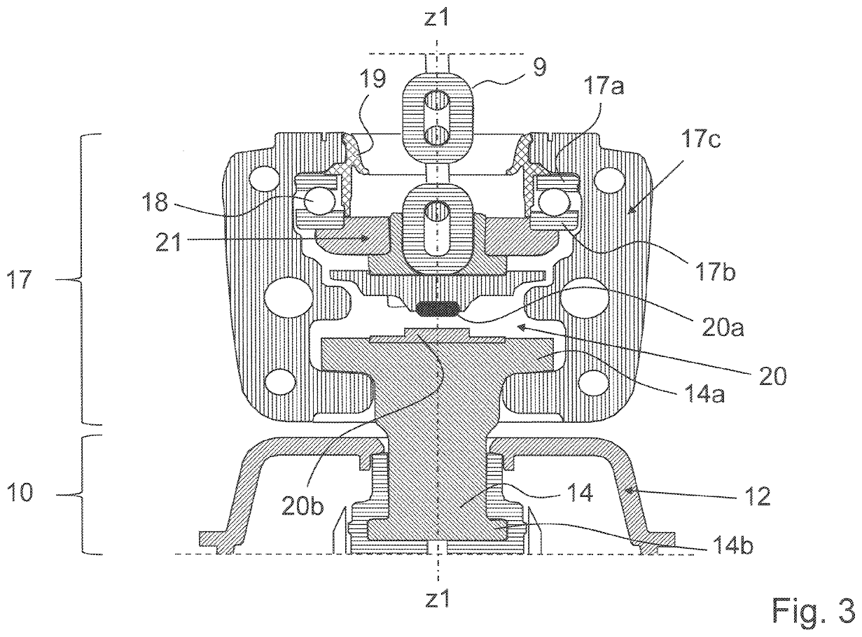

In order to be able to move the hoist 8 of the crane 1 in the travel plane E in a desired direction of travel by means of the travel drive intuitively, safely and efficiently, the crane 1 is provided with a system, in accordance with the present invention, for operating the crane 1 accordingly. The essential components of the system are the handling device 10, the operating element 16 and a sensor system 20 (see FIG. 3) for determining, in particular continuously, an orientation of the carrying means 9, and/or a part attached to the carrying means 9, in particular the handling device 10 and/or the load picking-up means 9a. The operating element 16 cooperates with the sensor system 20 via a signal-transmitting connection, not shown, such that by actuating the operating element 16, i.e. the “forwards travel” button 16a or “rearwards travel” button 16b thereof, a control command for actuating the travel drive with a desired directional value can be triggered. By way of the control command, the hoist 8 can then be moved in the travel plane E in a direction of travel corresponding to the desired directional value by means of the travel drive, wherein the desired directional value, or the direction of travel, is dependent upon an orientation determined by means of the sensor system 20. The desired direction of travel for the control command is specified in dependence upon the corresponding orientation by actuating the operating element 16, and can be changed by adjusting the respective orientation accordingly. The desired directional value can be specified by an evaluation unit connected to the sensor system 20 in a signal-transmitting manner and can be transmitted to the control unit 11 via a signal-transmitting connection, and the control command is then generated in the control unit. The evaluation unit can be incorporated, like the control unit 11, on or in the handling device 10.

In the present exemplified embodiment, the system, or the sensor system 20 thereof, is configured to determine an orientation of the handling device 10 as a part attached to the carrying means 9. This is an orientation that can be varied and thus adjusted by a rotation R of the handling device 10 about a rotational axis z1. For this purpose, the respective operator 13 can grasp the handling device 10, for example by the handle 15, with one hand 13a and can affect the desired rotation R by way of a corresponding manual force. The rotational axis z1 can extend in the direction of gravitational force and thus in an inclined manner with respect to the travel plane E. The section of the carrying means 9 suspended from the travel plane E, to which the handling device 10 and in particular also the load picking-up means 9a via the handling device 10 is attached, can also be located in its rest position and can likewise extend in the direction of gravitational force. In this context, the carrying means 9 itself can also be oriented according to the rotation R and for this purpose can be twisted about the rotational axis z1. However, since this is associated with an increased manual application of force for the operator 13 in order to compensate for a returning torque, produced owing to the twisting of the carrying means, the rotation of the handling device 10 optionally occurs relative to the carrying means 9. For this purpose, the handling device 10, in particular together and uniformly with the load picking-up means 9a and any possible load L attached thereto, is attached to the carrying means 9 so as to be rotatable relative thereto about the rotational axis z1 by means of a rotary arrangement 17. The carrying means 9 itself is not twisted about the rotational axis z1, or is at most twisted to a negligible extent. In order to minimise or prevent twisting of the carrying means 9, a hose 22 formed as a spiral hose is provided (see FIG. 2) which is used as an element for reducing twisting of the carrying means 9. The lower end of the hose 22 is connected to the section of the carrying means 9 suspended from the travel plane E for conjoint rotation therewith via the rotary arrangement 17, in particular indirectly via a rotary element of the rotary arrangement 17, which for its part is connected to the suspended section of the carrying means 9 for conjoint rotation therewith. The opposing upper end (not shown) of the hose 22 is likewise connected to the hoist 8, in particular the housing thereof, for conjoint rotation therewith in the region of the travel plane E. The hose 22 is configured such that its length is adjusted accordingly during lifting or lowering and the associated movement of the carrying means 9. The carrying means 9 is accommodated within the hose 22.

The orientation, which can be determined by means of the sensor system 20, is detected in the present exemplified embodiment in the form of a rotational angle W which can be adjusted by the rotation R of the handling device 10 about the rotational axis z1 and relative to the carrying means 9. One possible embodiment of the sensor system 20 is explained hereinunder with the aid of FIG. 3.

FIG. 2 shows a side view of more details of the handling device 10, suspended on the carrying means 9, from FIG. 1. In this enlarged illustration, it can be seen that the handling device 10 is coupled with the carrying means 9 via a connecting body 14 and the rotary arrangement 17. Opposite the rotary arrangement 17, the handling device 10, or the housing 12 thereof, includes a receptacle 10a for attaching the load picking-up means 9a in particular for conjoint rotation therewith. The rotary arrangement 17, in particular the housing 17c thereof, and the handling device 10, in particular housing 12, are connected to each other and to the carrying means 9 in a load-bearing manner by means of the connecting body 14. It is hereby possible to convey in particular the weight of the load L via the handling device 10, the connecting body 14 and the rotary arrangement 17, and to introduce same into the carrying means 9 from the rotary arrangement 17. The operating element 16 is arranged on the housing 12, in particular on the handle 15 thereon. The operating parts of the operating element 16 formed by the buttons 16a to 16d can also be seen. The operating element 16 and the buttons 16a to 16d thereof are formed in the present case as push-buttons to be mechanically actuated, each having at least one actuation stage. However, other embodiments in the sense defined in the introduction are also feasible.

It can also be seen that the handle 15 is formed to be grasped at least partially by one hand 13a, 13b of the operator 13, and at the same time to allow the operating element 16 or the buttons 16a to 16d to be reached using the same hand 13a, 13b. The handle 15 can also be used as a lever arm in order to be able to rotate the handling device 10 together with a suspended load L (see FIG. 1) smoothly about the rotational axis z1.

FIG. 3 shows a sectional view through the rotary arrangement 17 and a part of the handling device 10. An upper first rotary element 17a and a lower second rotary element 17b of the rotary arrangement 17 are incorporated within the housing 17c. The rotary elements 17a, 17b are rotatable relative to each other about the rotational axis z1 or define same. The rotary elements 17a, 17b are supported with respect to each other via in particular spherical rolling bodies 18 in order to form an axial bearing formed as a roller bearing, in particular a ball bearing. In order to protect against fouling, a sealing body 19 is further arranged and covers the gap between the two rotary elements 17a, 17b.

In order to attach and suspend the handling device 10 on the carrying means 9 in a load-bearing manner via the rotary arrangement 17, the handling device 10 is connected in particular with its housing 12 to the first rotary element 17a for conjoint rotation therewith with respect to the rotational axis z1, and the free end of the carrying means 9 is connected to the second rotary element 17b for conjoint rotation therewith with respect to the rotational axis z1. The load-bearing and conjoint-rotation connection between the handling device 10 and the first rotary element 17a is effected via the connecting body 14, which is supported on the one hand on the housing 17c with a first collar 14a and on the other hand on the housing 12 with a second collar 14b, and thus in each case in a form-fitting and frictional manner, and for this purpose engages in each case into the housing 17c and 12 through corresponding opposite openings. The likewise load-bearing and conjoint-rotation connection between the carrying means 9 and the second rotary element 17b are affected in the present case via a holding element 21, which is arranged within the housing 17c and is supported via the rotary elements 17a and 17b, and the rolling bodies on the housing wall of the housing 17c, wherein the rotary element 17a is in contact with the housing wall.

In order to be able to determine the respective rotational angle W of the handling device 10 relative to the rotational axis z1 as the orientation, the sensor system 20 is configured as a rotational angle sensor system, and in the present exemplified embodiment is attached completely to the carrying means 9. In this case, the sensor system 20 is arranged between the carrying means 9 and the handling device 10, in particular within the housing 17c. The sensor system 20 includes a magnetic body 20a and a sensor 20b cooperating therewith in the form of a Hall sensor configured as a 3D sensor, which permits determination of an absolute rotational angle W, and for this purpose defines a corresponding coordinate plane of the sensor system 20, which is used as a reference system for the orientation to be determined. In this case, the magnetic body 20a is connected to the holding element 21 for conjoint rotation therewith with respect to the rotational axis z1 and is supported thereby on a side facing away from the carrying means 9 and facing the handling device 10. Opposite the magnetic body 20a, the sensor 20b is connected to the handling device 10 for conjoint rotation therewith with respect to the rotational axis z1 and is arranged on the top side of the connecting body 14 located within the housing 17c. Of course, an inverse arrangement of the magnetic body 20a and sensor 20b is also possible.

Owing to the parts of the crane 1, which are connected to the rotary element 17a for conjoint rotation therewith with respect to the rotational axis z1, i.e. in particular the handling device 10, the connecting body 14 and the housing 17c, upon rotation R about the rotational axis z1, these are rotated together with the rotation R, whereas the parts connected to the rotary element 17b for conjoint rotation therewith with respect to the rotational axis z1, i.e. in particular the carrying element 9 and the holding element 21, remain in their non-rotated initial position. Owing to the arrangement, which is stationary relative to the rotational axis z1, of the rotary element 17b and the magnetic body 20a connected thereto for conjoint rotation therewith, a relative change in position of the sensor 20b and thus the entire rotational direction and the rotational angle W of the handling device 10 can be determined. Owing to this type and arrangement of the sensor system 20, the orientation can be determined in the form of the rotational angle W independently of any inclination of the rotational axis z1 with respect to the direction of gravitational force, such as when the load string swings with respect to the rest position or is intentionally deflected by the operator 13.

As an alternative to the determination of the orientation of the handling device 10, and the parts connected thereto for conjoint rotation therewith relative to a coordinate plane which is movable with the carrying means 9, it is also feasible that the orientation, in particular the respective rotational angle W can be determined relative to an overall, and in particular stationary, coordinate plane. For this purpose, the sensor system 20 can include for example an electronic compass, which then defines the coordinate plane of the sensor system 20. The determination of the orientation relative to such a coordinate plane has the advantage that clear results are possible irrespective of any possible rotation or twisting of the carrying means 9, and thus the coordinate plane about the rotational axis z1. In this context, other types and arrangements of the sensor system 20 are feasible, wherein in particular parts of the sensor system 20 defining the respective coordinate plane can also be arranged outside the carrying means 9 and/or outside the crane 1, in particular in a stationary manner relative to the crane 1 and its movements. In this case, the sensor system 20 can include, as described above, transmitting means and receivers in order to determine two reference points, defined for example on the handling device 10, and the orientation thereof.

Changes and modifications in the specifically-described embodiments may be carried out without departing from the principles of the present invention, which is intended to be limited only by the scope of the appended claims as interpreted according to the principles of patent law including the doctrine of equivalents.

1. A system for operating a load-handling crane, said system comprising:
a hoist movable in a travel plane by a travel drive of the crane, said hoist having a liftable and lowerable carrying means;
a handling device for operating the crane and configured to attach to said carrying means;
a sensor system for determining an orientation of a section of said carrying means, or a part attached to said carrying means that is suspended from the travel plane and extends in the direction of gravitational force, wherein the orientation is varied by rotation of said section or said part about a rotational axis extending in the direction of gravitational force; and
an operating element configured to cooperate with said sensor system in such a manner that by actuating said operating element a control command is triggered for actuating the travel drive so that said hoist is moved in the travel plane in a direction of travel by the travel drive and the direction of travel is dependent upon the orientation determined by said sensor system;
wherein said operating element comprises two operating parts, an actuation of which in each case triggers control commands for opposite directions of travel in terms of a forward travel and a rearward travel, wherein said two operating parts comprise a first button for the forward travel and a second button for the rearward travel, wherein each one of said two operating parts includes at least one actuation stage.

2. The system as claimed in claim 1, wherein a specification of the direction of travel for said travel drive that depends upon the determined orientation is effected as a predefined allocation of a directional vector to the determined orientation in such a manner that the specified direction of travel extends along, or in parallel with, a notional straight line representing the orientation, wherein the notional straight line contains two reference points that are defined in a mutually distinguishable manner on said section of said carrying means suspended from the travel plane or said respective part attached thereto used to determine the orientation, wherein a change in the orientation relative to a coordinate plane of said sensor system or said travel drive effects a correspondingly equal change in the directional vector and the direction of travel specified in dependence upon the determined orientation.

3. The system as claimed in claim 1 wherein the direction of travel is specified for the control command in dependence upon the determined orientation by actuating said operating element or another operating element of said system.

4. The system as claimed in claim 1, wherein said sensor system is configured to continuously determine the orientation and cooperate with said operating element configured to be actuated to specify the direction of travel in such a manner that the specified direction of travel remains unchanged or is continuously changed when said operating element is permanently actuated while the orientation changes.

5. The system as claimed in claim 1, wherein said sensor system is configured to determine the orientation of said section of said carrying means or the part attached thereto suspended from the travel plane, wherein the orientation is changeable by rotating said section or said part about the rotational axis and is independent of an inclination of the rotational axis with respect to the direction of gravitational force.

6. The system as claimed in claim 1, wherein sensor system is configured to be at least partially attached to said carrying means and to be arranged between said carrying means and the and said handling device.

7. The system as claimed in claim 1, further comprising a rotary arrangement that is configured to facilitate attachment of said handling device including at least one part of said sensor system to said carrying means, wherein said rotary arrangement is attached so as to be rotatable relative to said carrying means and about the rotational axis.

8. The system as claimed in claim 7, further comprising an element for reducing twisting of said carrying means, wherein said element is configured to be connected to said carrying means for conjoint rotation therewith.

9. The system as claimed in claim 7, wherein said rotary arrangement includes a housing with an opening, through which a connecting body that is connectable to said handling device is engaged and is supportable on said housing with a collar within said housing.

10. The system as claimed in claim 1, further comprising a load sensor configured to detect a weight of a load acting on said carrying means, wherein desired values for speed, acceleration, or deceleration of said travel drive are adaptable in dependence upon the detected weight of the load.

11. A load-handling crane comprising:
a travel drive;
a hoist moveable in a travel plane by the travel drive, said hoist having a liftable and lowerable carrying means;
a handling device for operating said crane and configured to attach to said carrying means;
a sensor system for determining an orientation of a section of said carrying means, or a part attached to said carrying means that is suspended from the travel plane and extends in the direction of gravitational force, wherein the orientation is varied by rotation of said section or said part about a rotational axis extending in the direction of gravitational force; and
an operating element configured to cooperate with said sensor system in such a manner that by actuating said operating element a control command is triggered for actuating the travel drive so that said hoist is moved in the travel plane in a direction of travel by the travel drive and the direction of travel is dependent upon the orientation determined by said sensor system;
wherein said operating element comprises two operating parts, an actuation of which in each case triggers control commands for opposite directions of travel in terms of a forward travel and a rearward travel, wherein said two operating parts comprise a first button for the forward travel and a second button for the rearward travel, wherein each one of said two operating parts includes at least one actuation stage.

12. A method for operating a load-handling crane, said method comprising:
providing a hoist movable in a travel plane by a travel drive of the crane, the hoist having a handling device for operating the crane, wherein the handling device is attached to a liftable and lowerable carrying means of the hoist and the hoist further comprising a sensor system and an operating element that cooperates with the sensor system;
determining by the sensor system an orientation of a section of the carrying means, or a part attached to the carrying means, wherein the sensor system is configured to determine the orientation of the section of the carrying means or of the part attached thereto, suspended from the travel plane and extending in the direction of gravitational force, and wherein the orientation is varied by rotating the section or the part about a rotational axis extending in the direction of gravitational force;
actuating the operating element to trigger a control command for actuating the travel drive to move the hoist in the travel plane in a direction of travel by the travel drive, wherein the direction of travel is based on the orientation determined by the sensor system, wherein the operating element comprises two operating parts, wherein actuation of the two operating parts in each case triggers control commands for opposite directions of travel in terms of a forward travel and a rearward travel, wherein the two operating parts are configured as a first button for the forward travel and a second button for the rearward travel, and wherein each button includes at least one actuation stage.

13. The method as claimed in claim 12, further comprising:
specifying the direction of travel for the travel drive based on the determined orientation and effected as a predefined allocation of a directional vector to the determined orientation in such a manner that the specified direction of travel extends along, or in parallel with, a notional straight line representing the orientation, wherein the notional straight line contains two reference points that are defined in a mutually distinguishable manner on the section of the carrying means or the part attached thereto and used to determine the orientation suspended from the travel plane, wherein a change in the orientation relative to a coordinate plane of the sensor system or the travel drive effects a correspondingly equal change in the directional vector and the direction of travel specified based upon the determined orientation.

14. The method as claimed in claim 13, wherein the direction of travel is specified for the control command based upon the determined orientation by actuating the operating element or another operating element.

15. The method as claimed in claim 13, wherein the specified direction of travel remains unchanged or is continuously varied when the operating element to be actuated to specify the direction of travel is permanently actuated and the orientation changes.

16. The system as claimed in claim 1, wherein said sensor system is configured for determining an orientation of said part attached to said carrying means, wherein said part comprises said handling device and/or a load picking-up means.

17. The load-handling crane of claim 11, wherein said determining the orientation by the sensor system comprises determining the orientation of the part attached to the carrying means, wherein the part comprises the handling device or a load picking-up means.

18. The load-handling crane of claim 11, wherein said sensor system is at least partially attached to said carrying means and is arranged between said carrying means and said handling device.

19. The load-handling crane of claim 11, further comprising a rotary arrangement, wherein said handling device together with at least one part of said sensor system are connected to said carrying means via said rotary arrangement, and wherein said rotary arrangement is attached to said carrying means so as to be rotatable relative to said carrying means and about the rotational axis.

20. The load-handling crane of claim 19, further comprising a connecting body for coupling said handling device with said rotary arrangement, wherein said rotary arrangement includes a housing with an opening, wherein one end of said connecting body extends through said opening and includes a collar supported by said housing of said rotary arrangement, and wherein another end of said connecting body is connected to and engages said handling device.
